(19) United States
(12) Patent Application Publication
(10) Pub. No.: US 2021/0031933 A1
(43) Pub. Date: Feb. 4, 2021

(54) POWER SYSTEM AND UNMANNED HELICOPTER

(71) Applicant: TIANJIN AURORA UNMANNED AEAIL SYSTEMS TECHNOLOGY CO., LTD., Tianjin (CN)

(72) Inventor: Shuguang Zhao, Tianjin (CN)

(21) Appl. No.: 16/968,044

(22) PCT Filed: Feb. 2, 2019
(86) PCT No.: PCT/CN2019/074595

§ 371 Date: Aug. 6, 2020

(30) Foreign Application Priority Data
Feb. 8, 2018 (CN) 201810127288.7

(51) Int. Cl. B64D 27/02; B64D 35/02; B64D 29/04; B64C 39/02

(52) U.S. Cl. CPC B64D 27/02; B64D 35/02; B64D 29/04; B64C 2201/108; B64C 2201/024; B64C 2201/044; B64C 39/024

(57) ABSTRACT

A power system includes a speed reducer, and a first turboshaft engine and a second turboshaft engine configured to drive the speed reducer. The speed reducer includes an output shaft. The first turboshaft engine is mounted on a first side of the speed reducer, the second turboshaft engine is mounted on a second side of the speed reducer, and the first turboshaft engine and the second turboshaft engine are arranged symmetrically about the output shaft.

The present application claims priority to Chinese patent application No. 201810127288.7 filed on Feb. 8, 2018, disclosure of which is incorporated herein by reference in its entirety.

### TECHNICAL FIELD

The present disclosure relates to the technical field of unmanned helicopters, for example, to a power system and an unmanned helicopter.

### BACKGROUND

In the related art, an unmanned helicopter is generally driven by a piston engine or a turboshaft engine. The piston engine has a large volume and weight, and produces significant vibration and noise during operation. Furthermore, a special cooling system is required to cool the engine to ensure long-term stable operation of the engine. Therefore, the piston engine is typically suitable for a single-engine unmanned helicopter. In contrast thereto, the turboshaft engine has a small volume and a light weight and produces less vibration, and so is suitable for a dual-engine unmanned helicopter. In most of the dual-engine unmanned helicopter designs, however, two engines are arranged side by side and exhaust ports are provided at the sides. Such a design causes the thrust generated by of the exhaust jets of the two turboshaft engines to counteract each other, resulting in waste of power.

### SUMMARY

The present disclosure provides a power system, and the power system can fully utilize thrust generated by exhaust jet of turboshaft engines.

The present disclosure further provides an unmanned helicopter, the unmanned helicopter can fully utilize thrust generated by exhaust jet of turboshaft engines, and installation of two engines is redesigned to make a structure more compact, thereby reducing the weight of the helicopter.

A power system includes a rotor, a speed reducer provided with the rotor and a first turboshaft engine and a second turboshaft engine configured to drive the speed reducer, and the speed reducer includes an output shaft. The first turboshaft engine is mounted on a first side of the speed reducer, the second turboshaft engine is mounted on a second side of the speed reducer, and the first turboshaft engine and the second turboshaft engine are arranged symmetrically about the output shaft. An exhaust jet direction of the first turboshaft engine is arranged to be opposite to an exhaust jet direction of the second turboshaft engine, such that torque generated by exhaust jet of the first turboshaft engine and the second turboshaft engine is opposite to torque generated by rotation of the rotor.

In one embodiment, there is further provided an unmanned helicopter including the above-mentioned power system.

### BRIEF DESCRIPTION OF DRAWINGS

FIG. 1 is a front view of a power system according to a first embodiment of the present disclosure.

FIG. 2 is a top view of FIG. 1.

FIG. 3 is a front view of a turboshaft engine fitted with a transmission assembly according to the first embodiment of the present disclosure.

FIG. 4 is a cross-sectional view of a turboshaft engine fitted with a transmission assembly according to the first embodiment of the present disclosure

FIG. 5 is a front view of a power system according to a second embodiment of the present disclosure.

FIG. 6 is a schematic view of connecting a speed reducer to a rotor according to an embodiment of the present disclosure.

### LIST OF REFERENCE SIGNS

| | |
|---|---|
| 20. First turboshaft engine | 30. Second turboshaft engine |
| 40. Rotor | 1. Speed reducer |
| 11. Output shaft | 12. Input shaft |
| 121. First input shaft | 122. Second input shaft |
| 2. Turboshaft engine | 21. Power shaft |
| 22. Exhaust port | 3. Transmission assembly |
| 301. First transmission assembly | 302. Second transmission assembly |
| 31. Synchronous belt | 32. Drive wheel |
| 321. Center shaft | 322. Belt wheel |
| 33. Driven wheel | 34. Coupling |
| 341. Input portion | 342. Output portion |
| 4. Nacelle | 5. Fixing bracket |
| 51. Bearing | 6. One-way clutch |

### DETAILED DESCRIPTION

### First Embodiment

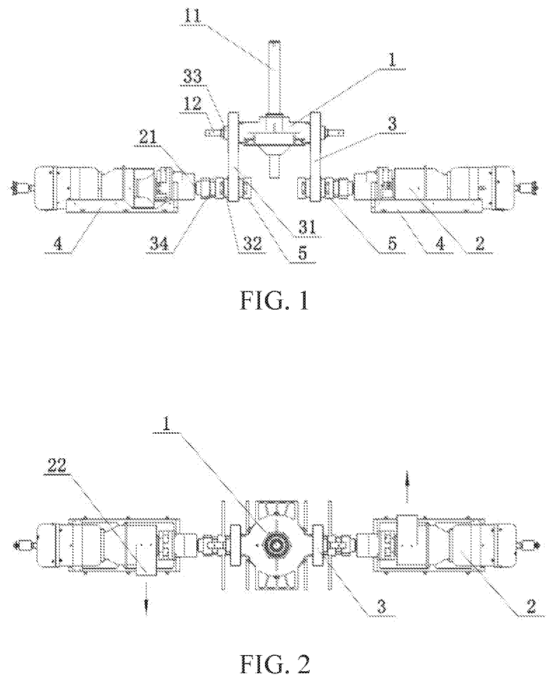

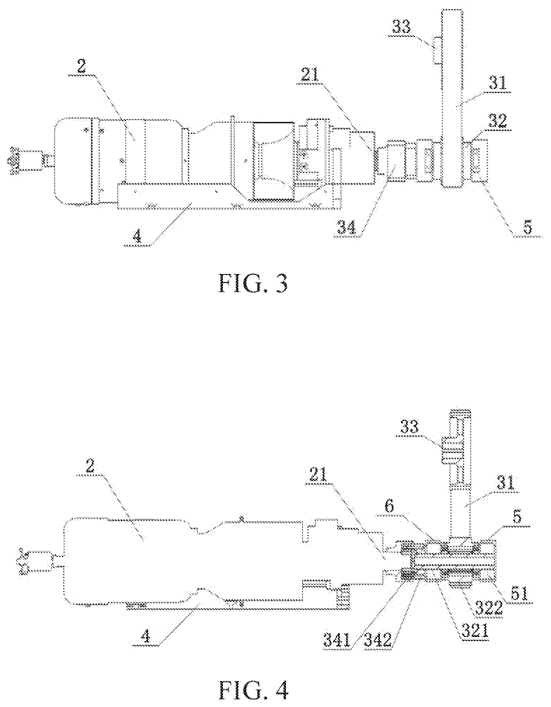

As illustrated in FIG. 1 to FIG. 4, this embodiment provides a power system including a speed reducer 1 provided with a rotor 40 of an unmanned helicopter and two turboshaft engines 2 driving the speed reducer 1. The two turboshaft engines 2 are mounted on two sides of the speed reducer 1, and are symmetrically arranged with respect to an output shaft 11. In an operation process, the two turboshaft engines 2 eject exhaust from exhaust ports 22 and have opposite exhaust jet directions (as shown by arrows in FIG. 2) from each other, such that torque generated by exhaust jet of the two turboshaft engines 2 is opposite to torque generated by rotation of the rotor 40.

In this embodiment, the torque generated by the exhaust jet of the two turboshaft engines 2 counteracts the torque generated by the rotation of the rotor 40, so that a load of a tail rotor of the unmanned helicopter can be effectively reduced, and effective power transmitted by the turboshaft engines 2 to the rotor 40 of the unmanned helicopter is greater, thereby improving a service efficiency of the engines.

The speed reducer 1 further includes two input shafts 12. As illustrated in FIG. 6, the rotor 40 is mounted on the output shaft 11, the two input shafts 12 are arranged in one-to-one correspondence with the two turboshaft engines 2, and both the two turboshaft engines 2 drive the two input shafts 12 to rotate through one transmission assembly 3. In the above-mentioned configuration, power of the two turboshaft engines 2 are coupled by using the speed reducer 1, which is safe and reliable.

The transmission assembly 3 includes a synchronous belt 31, a drive wheel 32 and a driven wheel 33. The drive wheel 32 is connected to a power shaft 21 of the turboshaft engine 2, the driven wheel 33 is connected to the input shaft 12 of the speed reducer 1, and the synchronous belt 31 surrounds outside the drive wheel 32 and the driven wheel 33, such that the drive wheel 32 and the driven wheel 33 can rotate synchronously. Through the above-mentioned configuration, the two turboshaft engines 2 can simply and reliably drive the two input shafts 12 to rotate by the transmission assembly 3 respectively, so transmission of the power is convenient and reliable.

In one embodiment, the drive wheel 32 is fixedly connected to the power shaft 21 through a coupling 34. In this embodiment, the coupling 34 is an elastic coupling. Through the above-mentioned configuration, the transmission assembly 3 is adapted to deviations during operation, and can accurately transmit the torque of the turboshaft engines 2.

The two input shafts 12 have a coincident axis, and the output shaft 11 is perpendicular to the input shaft 12. The above-mentioned configuration facilitates a symmetrical installation of the two turboshaft engines 2.

In this embodiment, the exhaust jet directions of the two turboshaft engines 2 are parallel to a plane of rotation of the rotor 40. The above-mentioned configuration makes the torque generated by the exhaust jet of the two turboshaft engines 2 greater.

In one embodiment, the output shafts 11 of the two turboshaft engines 2 have a coincident axis. In the above-mentioned configuration, driving forces of the two turboshaft engines 2 to the speed reducer 1 are more balanced on the basis of increasing the torque generated by the exhaust injection, thus improving the safety and reliability of the power system.

The power system of this embodiment further includes a nacelle 4. The nacelle 4 may be detachably connected to a fuselage of the unmanned helicopter, and the turboshaft engines 2 are fixed to the nacelle 4. Through the mating of the nacelle 4 and the turboshaft engines 2, the turboshaft engines 2 do not need to be directly installed in the fuselage of the unmanned helicopter, such that when the engine is overhauled or replaced, the nacelle 4 only needs to be removed from the fuselage of the unmanned helicopter; and when the overhaul or replacement of the engine is completed, the nacelle 4 is fixed on the fuselage of the unmanned helicopter. The overall operation is simple and convenient, which saves both time and labor. On the basis, by providing the coupling 34, the turboshaft engines 2 mounted on the fuselage of the unmanned helicopter through the nacelle 4 can be more flexibly and conveniently connected to the transmission assembly 3, and through the mating with the nacelle 4, the transmission assembly 3 does not need to be moved, thus further improving convenience of dismounting and installation of the turboshaft engines 2. Through the above-mentioned nacelle 4, the installation of the two turboshaft engines 2 can be completed without changing the structure of the fuselage of the unmanned helicopter, and an adjustment of the turboshaft engines 2 is simple and convenient, such that the torque generated by the exhaust jet of the two turboshaft engines 2 can counteract the torque generated by the rotation of the rotor 40.

The power system of this embodiment further includes a fixing bracket 5, and the drive wheel 32 can be rotatable arranged on the fixing bracket 5 along an axis of the drive Wheel 32.

In one embodiment, the fixing bracket 5 is provided with a bearing 51, and the drive wheel 32 includes a center shaft 321 and a belt wheel 322 sleeved outside the center shaft 321. The synchronous belt 31 surrounds the belt wheel 322. The center shaft 321 is arranged on the fixing bracket 5 through the bearing 51, passes through one side of the fixing bracket 5 and is fixedly connected to the power shaft 21 through coupling 34. By providing the bearing 51, the drive wheel 32 can accurately and reliably transmit the power of the turboshaft engines 2 to the synchronous belt 31 surrounding outside the belt wheel 322.

In one embodiment, the coupling 34 includes an input portion 341 and an output portion 342 for transmission connection. The input portion 341 is sleeved tightly outside the power shaft 21, and the output portion 342 is sleeved tightly outside the center shaft 321. Through the above-mentioned configuration, the reliability of the dismounting and installation of the turboshaft engines 2 is improved, and the reliability of the connection between the turboshaft engines 2 and the transmission assembly 3 is ensured after the overhaul or replacement of the engine.

In one embodiment, the belt wheel 322 is sleeved outside the center shaft 321 through a one-way clutch 6. The arrangement of the one-way clutch 6 ensures that only one-way force can be transmitted by the transmission assembly 3, so that the whole power system is more reliable.

In this embodiment, the nacelle 4 is provided with a mounting hole (not shown in the figure) in which a screw (not shown in the figure) is provided, and the screw is connected to the fuselage of the unmanned helicopter, such that the nacelle 4 is fixedly connected to the fuselage of the unmanned helicopter. In this embodiment, six mounting holes are provided, and the number of the mounting holes can be any other one, depending on sizes of the turboshaft engines 2 and the fuselage of the unmanned helicopter. The above-mentioned configuration enables that when the nacelle 4 is dismounted and installed, only six screws need to be removed by a spanner.

This embodiment further provides an unmanned helicopter including the above-mentioned power system.

In the unmanned helicopter of this embodiment, the torque generated by the exhaust jet of the two turboshaft engines 2 counteracts the torque generated by the rotation of the rotor 40, such that the load of the tail rotor of the unmanned helicopter can be effectively reduced, and the effective power transmitted by the turboshaft engines 2 to the rotor 40 of the unmanned helicopter is greater, thereby improving the service efficiency of the engines 2. Moreover, a layout arrangement of the two turboshaft engines 2 can effectively reduce a width of the unmanned helicopter, such that a structure of the unmanned helicopter is more compact, thereby reducing a weight of the whole body.

### Second Embodiment

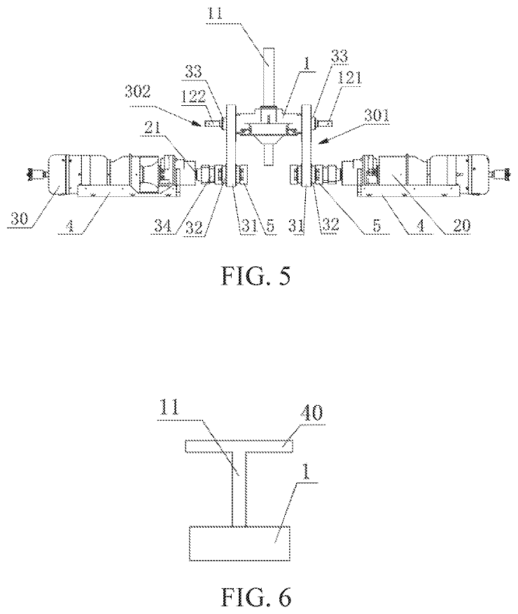

This embodiment provides a power system, and as illustrated in FIG. 5 and FIG. 6, the power system includes a speed reducer 1 and a first turboshaft engine 20 and a second turboshaft engine 30 configured to drive the speed reducer 1, where the speed reducer 1 includes an output shaft 11.

The first turboshaft engine 20 is mounted on a first side of the speed reducer 1, the second turboshaft engine 30 is mounted on a second side of the speed reducer 1, and the first turboshaft engine 20 and the second turboshaft engine 30 are symmetrically arranged about the output shaft 11. An exhaust jet direction of the first turboshaft engine 20 is opposite to an exhaust jet direction of the second turboshaft engine 30, such that torque generated by exhaust jet of the first turboshaft engine 20 and the second turboshaft engine 30 is opposite to torque generated by rotation of a rotor 40.

In one embodiment, the power system further includes a first transmission assembly 301 and a second transmission assembly 302. The speed reducer 1 includes a first input shaft 121 and a second input shaft 122, where the first input shaft 121 is arranged corresponding to the first turboshaft engine 20, and the second input shaft 122 is arranged corresponding to the second turboshaft engine 30. The first turboshaft engine 20 is configured to drive the first input shaft 121 to rotate through the first transmission assembly 301, and the second turboshaft engine 30 is configured to drive the second input shaft 122 to rotate through the second transmission assembly 302.

In one embodiment, both the first turboshaft engine 20 and the second turboshaft engine 30 include a power shaft 21, and the first transmission assembly 301 and the second transmission assembly 302 each include a synchronous belt 31, a drive wheel 32 and a driven wheel 33. The drive wheel 32 of the first transmission assembly 301 is connected to the power shaft 21 of the first turboshaft engine 20, and the driven wheel 33 of the first transmission assembly 301 is connected to the first input shaft 121. The drive wheel 32 of the second transmission assembly 302 is connected to the power shaft 21 of the second turboshaft engine 30, the driven wheel 33 of the second transmission assembly 302 is connected to the second input shaft 122; and in the first transmission assembly 301 and the second transmission assembly 302, the synchronous belt 31 surrounds outside the drive wheel 32 and the driven wheel 33.

In one embodiment, the power system further includes a coupling 34, where in the first transmission assembly 301 and the second transmission assembly 302, the drive wheel 32 is fixedly connected to the power shaft 21 through the coupling 34. The coupling 34 is an elastic coupling.

In one embodiment, an axis of the first input shaft 121 is coincident with an axis of the second input shaft 122, and the output shaft 11 is perpendicular to the first input shaft 121 and the second input shaft 122.

In one embodiment, the power system further includes a nacelle 4, where both the first turboshaft engine 20 and the second turboshaft engine 30 are fixed to the nacelle 4.

In one embodiment, the power system further includes a fixing bracket 5, where the drive wheel 32 is rotatably arranged on the fixing bracket 5 along an axis of the drive wheel 32.

This embodiment further provides an unmanned helicopter including the above-mentioned power system, a fuselage and a rotor 40. The nacelle 4 of the power system is configured to be detachably connected to the fuselage, the fixing bracket 5 of the power system is arranged on the fuselage and fixedly connected to the fuselage, and the rotor 40 is installed on the speed reducer 1.

In one embodiment, an exhaust jet direction of the first turboshaft engine 20 and an exhaust jet direction of the second turboshaft engine 30 are parallel to a plane of rotation of the rotor 40.

Other structures and functions of the power system in this embodiment are the same as structures and functions in embodiment one, and will not be repeated herein.

1. A power system, comprising:
a speed reducer; and
a first turboshaft engine and a second turboshaft engine, configured to drive the speed reducer, wherein the speed reducer comprises an output shaft;
wherein the first turboshaft engine is mounted on a first side of the speed reducer, the second turboshaft engine is mounted on a second side of the speed reducer, and the first turboshaft engine and the second turboshaft engine are symmetrically arranged about the output shaft; and an exhaust jet direction of the first turboshaft engine is arranged to be opposite to that of the second turboshaft engine, causing a torque generated by exhaust jets of the first turboshaft engine and the second turboshaft engine to be opposite to a torque generated by rotation of the speed reducer.

2. The power system of claim 1, further comprising a first transmission assembly and a second transmission assembly, wherein the speed reducer comprises a first input shaft and a second input shaft, wherein the first input shaft is arranged corresponding to the first turboshaft engine, and the second input shaft is arranged corresponding to the second turboshaft engine; and the first turboshaft engine is configured to drive the first input shaft to rotate through the first transmission assembly, and the second turboshaft engine is configured to drive the second input shaft to rotate through the second transmission assembly.

3. The power system of claim 2, wherein both the first turboshaft engine and the second turboshaft engine each comprise a power shaft, and both the first transmission assembly and the second transmission assembly each comprise a synchronous belt, a drive wheel and a driven wheel; the drive wheel of the first transmission assembly is connected to the power shaft of the first turboshaft engine, and the driven wheel of the first transmission assembly is connected to the first input shaft; the drive wheel of the second transmission assembly is connected to the power shaft of the second turboshaft engine, the driven wheel of the second transmission assembly is connected to the second input shaft; and in each of the first transmission assembly and the second transmission assembly, the synchronous belt is arranged around a circumference of the drive wheel and the driven wheel.

4. The power system of claim 3, further comprising a coupling, wherein in each of the first transmission assembly and the second transmission assembly, the drive wheel is fixedly connected to the power shaft through the coupling.

5. The power system of claim 4, wherein the coupling is an elastic coupling.

6. The power system of claim 3, wherein an axis of the first input shaft is coincident with an axis of the second input shaft, and the output shaft is perpendicular to the first input shaft and the second input shaft.

7. The power system of claim 1, further comprising a nacelle, wherein each of the first turboshaft engine and the second turboshaft engine is fixed to the nacelle.

8. The power system of claim 3, further comprising a fixing bracket, wherein the drive wheel is rotatably arranged on the fixing bracket and is rotatable along an axis of the drive wheel.

9. An unmanned helicopter, comprising a power system, the power system comprising:
a speed reducer; and
a first turboshaft engine and a second turboshaft engine, configured to drive the speed reducer, wherein the speed reducer comprises an output shaft;
wherein the first turboshaft engine is mounted on a first side of the speed reducer, the second turboshaft engine is mounted on a second side of the speed reducer, and the first turboshaft engine and the second turboshaft engine are symmetrically arranged about the output shaft; and an exhaust jet direction of the first turboshaft engine is arranged to be opposite to that of the second turboshaft engine, causing a torque generated by exhaust jets of the first turboshaft engine and the second turboshaft engine to be opposite to a torque generated by rotation of the speed reducer.

10. The unmanned helicopter of claim 9, further comprising a fuselage and a rotor, wherein a nacelle of the power system is detachably connected to the fuselage, and a fixing bracket of the power system is arranged on and fixedly connected to the fuselage, and the rotor is installed on the speed reducer.

11. The unmanned helicopter of claim 10, wherein exhaust jet directions of the first turboshaft engine and the second turboshaft engine are parallel to a plane of rotation of the rotor.

12. The power system of claim 2, further comprising a nacelle, wherein each of the first turboshaft engine and the second turboshaft engine is fixed to the nacelle.

13. The power system of claim 3, further comprising a nacelle, wherein each of the first turboshaft engine and the second turboshaft engine is fixed to the nacelle.

14. The unmanned helicopter of claim 9, wherein the power system further comprises a first transmission assembly and a second transmission assembly, wherein the speed reducer comprises a first input shaft and a second input shaft, wherein the first input shaft is arranged corresponding to the first turboshaft engine and the second input shaft is arranged corresponding to the second turboshaft engine; and the first turboshaft engine is configured to drive the first input shaft to rotate through the first transmission assembly, and the second turboshaft engine is configured to drive the second input shaft to rotate through the second transmission assembly.

15. The unmanned helicopter of claim 14, wherein both the first turboshaft engine and the second turboshaft engine each comprise a power shaft, and both the first transmission assembly and the second transmission assembly each comprise a synchronous belt, a drive wheel and a driven wheel; the drive wheel of the first transmission assembly is connected to the power shaft of the first turboshaft engine, and the driven wheel of the first transmission assembly is connected to the first input shaft; the drive wheel of the second transmission assembly is connected to the power shaft of the second turboshaft engine, the driven wheel of the second transmission assembly is connected to the second input shaft; and in each of the first transmission assembly and the second transmission assembly, the synchronous belt is arranged around a circumference of the drive wheel and the driven wheel.

16. The unmanned helicopter of claim 15, further comprising a coupling, wherein in each of the first transmission assembly and the second transmission assembly, the drive wheel is fixedly connected to the power shaft through the coupling.

17. The unmanned helicopter of claim 16, wherein the coupling is an elastic coupling.

18. The unmanned helicopter of claim 15, wherein an axis of the first input shaft is coincident with an axis of the second input shaft, and the output shaft is perpendicular to the first input shaft and the second input shaft.

19. The unmanned helicopter of claim 9, further comprising a nacelle, wherein each of the first turboshaft engine and the second turboshaft engine is fixed to the nacelle.

20. The unmanned helicopter of claim 15, further comprising a fixing bracket, wherein the drive wheel is rotatably arranged on the fixing bracket and is rotatable along an axis of the drive wheel.
